(19) United States
(12) Patent Application Publication
(10) Pub. No.: US 2017/0157878 A1
(43) Pub. Date: Jun. 8, 2017

(54) Screw Press and Method for its Maintenance

(71) Applicant: HUBER SE, Berching (DE)

(72) Inventors: Harald Neumann, Beilngries (DE); Andreas Beck, Neumarkt (DE)

(21) Appl. No.: 15/367,717

(22) Filed: Dec. 2, 2016

(30) Foreign Application Priority Data
Dec. 4, 2015 (DE) 10 2015 121 163.7

(51) Int. Cl. B30B 9/12

(52) U.S. Cl. CPC B30B 9/128

(57) ABSTRACT

The invention relates to a screw press (1) for dewatering sludge, whereas the screw press (1) features at least one inlet opening (2) for the sludge to be dewatered, whereas the screw press (1) features a pressing assembly, with the assistance of which the sludge is able to undergo a pressing process after passing the inlet opening (2), with which the liquid (9) present in the sludge is at least partially driven out of the sludge, whereas a pressing assembly comprises a worm shaft (4) that is movable in a rotational movement with the assistance of a drive (17) and several screen elements (5) surrounding the worm shaft (4), at least in sections, during the operation of the screw press (1), whereas the screen elements (5) feature a screen surface (6) turned towards the worm shaft (4) and a support structure (7) securing the stability of the screen elements (5), whereas the pressing assembly features at least one outlet opening (8) for the liquid (9) driven out of the sludge with the assistance of the worm shaft (4), and whereas the screw press (1) features at least one discharge opening (10) for the sludge (11) that is at least partially dewatered with the assistance of the pressing assembly. In accordance with the invention, it is proposed that the screw press (1) features at least one holding unit (12), with the assistance of which at least the support structure (7) of at least one screen element (5) can be fixed in a maintenance position, in which the screen surface (6) of the corresponding screen element (5) is spaced apart from the worm shaft (4).

The present invention relates to a screw press for dewatering sludge, whereas the screw press features at least one inlet opening for the sludge to be dewatered, whereas the screw press features a pressing assembly, with the assistance of which the sludge is able to undergo a pressing process after passing the inlet opening, with which the liquid present in the sludge is least partially driven out of the sludge, whereas a pressing assembly comprises a worm shaft that is movable in a rotational movement with the assistance of a drive and several screen elements surrounding the worm shaft, at least in sections, during the operation of the screw press, whereas the screen elements feature a screen surface turned towards the worm shaft and a support structure—securing the stability of the screen elements, whereas the pressing assembly features at least one outlet opening for the liquid driven out of the sludge with the assistance of the worm shaft, and whereas the screw press has at least one discharge opening for the sludge that is at least partially dewatered with the assistance of the pressing assembly.

Screw compressors conforming to this type are known in the state of the art and are used for the dewatering of sludge, as is the case, for example, in sewage treatment plants. The sludge (suspension from an aqueous liquid and solids contained therein) fed to the screw press is subjected to a pressing process with the assistance of a worm shaft, with which liquid is driven out of the sludge in order to reduce the water content of the sludge and to feed the dewatered sludge to a further production step. During the pressing process, the sludge is transported from the worm shaft in the direction of a discharge opening, and is thereby compressed by the decreasing gap between adjacent worm shaft sections. The liquid that is thus pressed out of the sludge arrives into a filtrate tank through the screen elements surrounding the worm shaft, from which it is ultimately withdrawn through an outlet opening and, for example, is fed to a further filtration.

In order to, during the pressing process, ensure that the sludge is transported by the worm shaft in the direction of the discharge opening, and that the openings of the screen elements are always freed from retained sludge solids, the worm shafts (which are usually made of metal) to be used have, on their edge turned towards the screen surface, a scraper profile (for example, made of plastic), which in turn rest on the screen surface as closely as possible. However, such scraper profiles wear out over time, such that they have to be replaced at regular intervals. However, since, during the operation of the screw press, the scraper profiles rest tightly on the screen surface, they can only be changed after a partial or complete removal of the screen elements, since access from the outside is ensured only at that point.

Up to now, the known screw presses have, to some extent, a multiple number of screen elements, which together form a screen basket surrounding the worm shaft. If the scraper profile of the worm shaft is to be replaced, the screen element pointing upwards when the screw press stops (after releasing corresponding connections) is lifted. Subsequently, the lower screen element must also be completely removed from the screw press and put down separately, in order to completely release the worm shaft. Therefore, the maintenance work is complex and thus time-consuming and cost-intensive, whereas, additionally in the area of the screw press, a certain storage space for the removed screen elements must be made available.

The task of this invention is to propose a screw press that is improved in view of the above disadvantages compared to the state of the art, along with a method for its maintenance.

The task is achieved by a screw press and a method with the characteristics of the independent claims.

The screw press in accordance with the invention, which serves the purpose of the dewatering of sludge, comprises at least one inlet opening for the sludge to be dewatered, along with a pressing assembly, with the assistance of which the sludge fed through the inlet opening can be subjected to a pressing process, with which the liquid present in the sludge is least partially driven out of the sludge. For this purpose, the pressing assembly comprises a worm shaft that is movable in a rotational movement with the assistance of a drive and several screen elements surrounding the worm shaft, at least in sections, during the operation of the screw press.

As a rule, the worm shaft has an inner axis, around which at least one worm spiral (comparable to an Archimedean screw) extends, whereas the gap between adjacent spiral sections in the conveying direction of the sludge is to be decreased at least in sections, in order to effect the desired compression of the sludge.

The screen elements surround the worm shaft, such that, during the transport through the rotating worm shaft, the sludge is pressed laterally against the screen elements and is thereby dewatered, since the liquid can pass through the screen openings of the screen surface, while the majority of the solids are retained. In order to withstand the pressure present in this case, the screen elements feature, in addition to the screen surface, a support structure that ensures the stability of the screen elements. The screen elements may be present in the form of a perforated plate or slotted plate with a thickness of several millimeters up to one centimeter, such that, in this case, the support structure is designed to be flat and is formed by the plate itself, which in turn features a screen surface (=surface of the plate) turned towards the worm shaft. However, it is also conceivable that the actual screen surface is formed by a relatively thin material, for example, a perforated plate or a screen plate that is only 1 to 5 millimeters thick, which would be bent outwards without an additional support structure during the operation of the screw press. The support structure may comprise, for example, support rings that, on the side of the screen surface turned away from the worm shaft extend by the material forming the screen surface, and support such material towards the outside. Of course, the support structure may also feature a different shaping or, in addition or alternatively, different longitudinal and/or transverse struts, and thus form a kind of support frame for the section of the screen element featuring the screen surface. Thus, the screen elements may be designed in particular in one or more parts.

Furthermore, the pressing assembly at least comprises an outlet opening for the liquid driven out of the sludge with the assistance of the worm shaft, which is connected, for example, to a filtrate tank arranged below the worm shaft, in which the liquid (=filtrate) pressed out of the sludge is collected during the operation of the screw press.

Finally, the screw press has at least one discharge opening for the sludge, which is at least partially dewatered with the assistance of the pressing assembly, whereas, in the area of the discharge opening, an adjustable press element is to be provided, with the assistance of which the passage surface of the discharge opening can be changed, in order to be able to adjust the counter-pressure during the pressing process,

As already mentioned above, it is necessary to service the worm shaft at regular intervals. This includes the replacement of any scraper profile, the removal of jammed solids, such as stones, or the complete replacement of the worm shaft.

In order to simplify the corresponding maintenance work, in which the screen elements (or a part thereof) must first be removed, in accordance with the invention, it is now proposed that the screw press has at least one holding unit, with the assistance of which at least the support structure of at least one screen element can be fixed in a maintenance position, in which the screen surface of the corresponding screen element is spaced apart from the worm shaft. In other words, the screw press thus comprises its own means (in the form of the one or more holding units), with the assistance of which the support structure(s) of one or more screen elements or, on the other hand, the screen elements as a whole (that is, with the associated screen surface) are fixed in a position that deviates from the position that they feature during the operation of the screw press (here, the screen surfaces of all of the screen elements rest on the worm shaft).

The holding unit may be formed, for example, by a support surface, on which the corresponding screen element or its support structure can be lowered into its maintenance position. In any event, the corresponding holding unit (of which several may also be present) is a component of the screw press, such that at least one part of the screen elements or their support structures no longer have to be completely removed from the screw press during the maintenance of the worm shaft or its components. Rather, the specified sections (the screen element or its support structure) can be moved into a maintenance position within the screw press from an operating position, in which the respective screen surface rests as closely as possible to the worm shaft, and are fixed at such point, in which the screen surface is spaced apart from the worm shaft to the extent that it can be serviced. Within the framework of the invention, the term “fix” is to be understood as a stationary holding of the corresponding section, whereas it is sufficient, for example, for the respective section to rest on the holding unit and to be held in place by its own weight.

It is particularly advantageous if the screw press features a multiple number of screen elements that together form a screen jacket, whereas the screen jacket at least partially features a cylindrical basic shape. For example, the screen elements can be constructed in the same manner. Furthermore, the screen elements are to feature a basic shape that corresponds to the shape of a cylinder section that is produced by cutting a cylinder parallel to its axis of rotation one or more times.

It is particularly advantageous if the screw press comprises two screen elements, which are also preferably formed in the same manner and are connected to each other in a fixed manner (for example, by screwing) during the operation of the screw press with the assistance of corresponding connecting elements. If the aforementioned maintenance work is to be carried out, a screen element, or at least the support structure thereof, can be removed from the top after loosening the corresponding connecting elements (for example, with the assistance of a lifting tool), and the second screen element or at least its support structure can be lowered downwards until it makes contact with the holding unit (if only the support structure is lowered, the section of the screen element forming the screen surface can be removed (for example, by hand) from the screw press; under some circumstances, this “sticks” after lowering the support structure to the worm spiral). In this case, the holding unit(s) is/are located preferably below the axis of rotation of the worm shaft and, in any event, preferably within the screw press (for example, behind an outer lining thereof). Furthermore, at least one screen element, in particular its support structure, is to have one or several contact surfaces corresponding to the holding unit(s), through which it rests in the maintenance position, preferably on the holding unit(s).

In general, the holding unit(s) is/are to be provided as a support surface, onto which the support structure of one or more screen elements can be put down, or comprises a support surface. In addition, the holding unit(s) is/are to be arranged below the worm shaft in a side view of the screw press (the axis of rotation of the worm shaft generally runs horizontally or is slightly inclined to the horizontal). In addition or alternatively, an arrangement at the height of the worm shaft or above the worm shaft would also be conceivable, in order to, for example, fix a screen element or its support structure, which is located at the top when the worm shaft is at a standstill, after its raising with the assistance of the holding unit(s) in a corresponding maintenance position.

It is also highly advantageous if the individual support structures are spaced apart from the holding unit(s) in the operating position of the screen elements (that is, the position that they occupy during the operation of the screw press). Thus, the respective support structures initially must be removed a distance from the worm shaft, until they come into contact with the holding unit(s) and can be fixed by it/them. Thus, the support structures are not in contact with the holding unit(s) in the operating position of the corresponding screen elements. In particular, it is also advantageous if the holding unit(s) is/are arranged in a stationary and immovable manner with respect to a base carrier of the screw press, on which the individual components (such as, for example, the worm shaft) are mounted directly or indirectly.

It is advantageous if the holding unit(s) is/are arranged in a side view of the screw press, at least in sections, below an axis of rotation of the worm shaft, such that at least the support structure of a screen element can be lowered, prior to maintenance work on the screw press, downward until it makes contact at the holding unit(s).

In general, the holding unit(s) are to be placed in such a manner that the support structure(s) or the screen element(s) featuring the corresponding support structure(s), in the respective maintenance position, is/are not in contact with the base on which the screw press is located. Rather, it is advantageous if the respective support structure or the respective screen element is held in a stationary manner and above the base, in the maintenance position, within the screw press with the assistance of one or more holding unit(s).

It is also advantageous if the holding unit is a component of a base carrier, which serves, among other things, for the mounting of the worm shaft, or is fastened directly or indirectly to the base carrier. As a rule, the base carrier comprises one or more supporting feet, through which the screw press is placed on a base. Furthermore, the base carrier may feature longitudinal and/or transverse struts, which form a frame structure of the screw press, whereas the holding unit(s) preferably is or are fixed to one or more of the specified struts or is or are component(s) of the same.

It is also highly advantageous if the holding unit is mounted in a movable manner. For example, the holding unit could be movable around a pivot axis or a rotational axis from an initial position into a stop position. As a result, the movement of the support structure to be brought into connection with the respective holding unit can be simplified. For example, it would be conceivable to initially transfer a support structure or the screen element featuring the support structure from the operating position into the maintenance position, and to subsequently move the corresponding holding unit(s) from the initial position into the holding position.

Likewise, it is also advantageous if the support structure, which is in contact with the holding unit in its maintenance position, can be lowered, starting from its operating position, by a maximum of 20 cm, preferably by a maximum of 15 cm, before it comes into contact with the holding unit. The correspondingly dimensioned lowering ensures that a scraper profile of the worm shaft can be exchanged after lowering without any problem (since friction between the scraper profile and the worm shaft no longer prevails when it is rotated), whereas the screw press nevertheless can be built to be as compact as possible. Preferably, the holding unit(s) is/are placed in such a manner that the corresponding support structure can be brought into contact with the holding unit(s) by means of a parallel displacement.

It is also advantageous if the screw press also features a filtrate tank for collecting the liquid emerging from the sludge during the operation of the screw press, whereas, in a side view of the screw press, the filtrate tank is arranged, at least in sections, below the worm shaft. In this connection, it is also advantageous if the holding unit(s) is/are designed in such a manner that a support structure of a screen element arranged between the worm shaft and the filtrate tank during the standstill of the worm shaft comes into contact with the holding unit during lowering into its maintenance position, and is thereby fixed in a position in which the specified support structure is arranged above the filtrate tank. In this case, the filtrate tank does not have to be removed from the screw press or displaced inside the same, before the specified support structure is moved into its maintenance position or from there back into its operating position. Thus, the corresponding support structure can be moved, starting from its operating position, in the direction of the filtrate tank into its maintenance position, and is located in both positions above the filtrate tank, whereas the gap between the support structure and the filtrate tank is smaller in the maintenance position than in the operating position.

Furthermore, a method for the maintenance of a screw press is proposed, whereas the screw press is formed in accordance with the preceding or following description. The method comprises at least the steps described in the following:

In order to remove the screen elements at least a distance from the worm shaft, at least the support structure of at least one screen element, or the corresponding screen element as a whole, is moved into a position that deviates from the intended operating position during the operation of the screw press. Preferably, the specified support structure is raised for this purpose. In the maintenance position deviating from the operating position, it is fixed or completely removed from the remaining components of the screw press (for example, put down at the base). At the same time, or temporarily upstream or downstream, the support structure of at least one additional screen element is brought into a maintenance position, in which at least the support structure of the additional screen element is in contact with at least one holding unit of the screw press and is fixed apart from it in a manner spaced apart from the worm shaft. If the screw press has more than two screen elements, one or more screen elements or their support structures can be completely removed from the screw press and one or more screen elements or their support structures can be removed from the worm shaft and fixed, with the assistance of the described holding unit(s), within the screw press.

As soon as all the screen elements are spaced apart from the worm shaft, the necessary maintenance work is carried out, which includes, for example, the replacement of worn components of the worm shaft, such as, in particular, a scraper profile. After the maintenance work has been completed, the support structure(s) previously transferred into its maintenance position can be brought back into their operating position, in which the screen surface(s) allocated to the support structure(s) rest(s) on the worm shaft, at least in sections.

In contrast to the state of the art, at least one support structure of a screen element or a complete screen element (featuring a screen surface cooperating with a support structure) remains within the screw press even during the maintenance work. Thus, the corresponding support structure or the corresponding screen element is moved solely within the screw press, and is fixed in either the maintenance position or the operating position. Thus, a complicated removal of this support structure or this screen element is not necessary, compared to the state of the art.

In particular, it is advantageous if at least the support structure of the specified at least one additional screen element is lowered into its maintenance position, and is lifted back into its operating position after the maintenance work has been carried out. The lowering and subsequent lifting can be effected with the assistance of a suitable separate lifting device or a lifting device formed as a part of the screw press (for example, a pneumatic or threaded rod assembly), whereas the lowering movement is finally terminated through the contact of he support structure with the holding unit(s), on which the support structure comes to rest,

It is also advantageous if the support structure of the specified at least one additional screen element is lowered by a maximum of 20 cm, preferably by a maximum of 15 cm, before, starting from its operating position, it comes into contact with the holding unit, and is fixed by this (that is, held in a stationary manner) in its maintenance position, preferably inside the screw press. Preferably, the movement takes place in the form of a parallel displacement; that is, all points of the moving support structure or the moving screen element are moved by the same amount in the same direction.

It is also advantageous if the support structure of the specified at least one additional screen element, or the screen element as a whole, is lowered from its operating position into its maintenance position, or is raised from its maintenance position into its operating position, in a direction that is at least partially linear, and preferably completely linear (or the reverse; that is, it is lifted from its operating position into its maintenance position, or is lowered from its maintenance position into its operating position).

It is particularly advantageous if the support structure of the specified at least one additional screen element is lowered from its operating position into its maintenance position, or is raised from its maintenance position into its operating position, in the vertical direction or in the radial direction with respect to the axis of rotation of the worm shaft (or the reverse). In addition, the screw press may feature one or more guides, in order to ensure a tilt-free movement of the support structure(s) or of the corresponding screen element(s).

Further advantages of the invention are described in the following embodiments. The following is shown, in each case schematically:

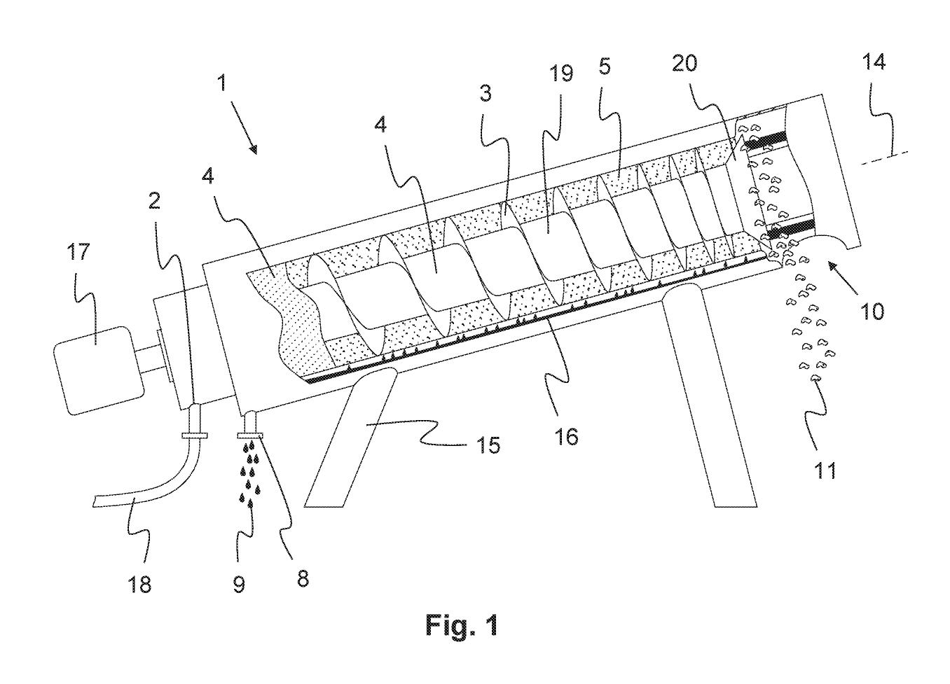

FIG. 1 a partially cut screw press in a side view,

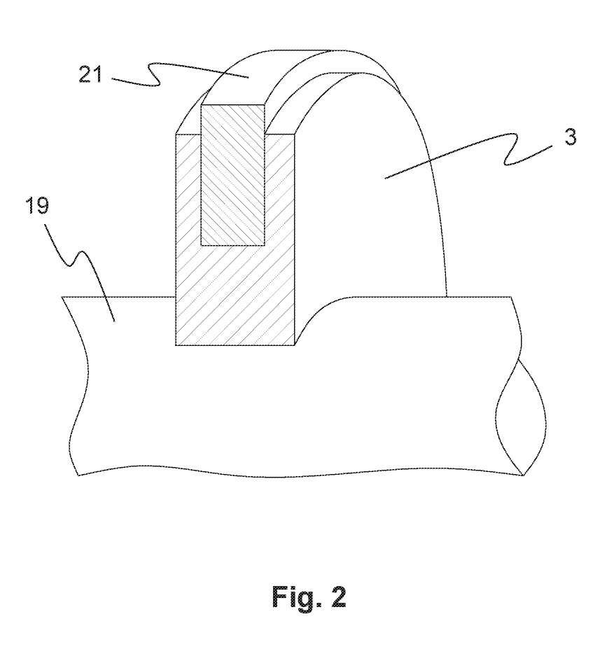

FIG. 2 a section of a worm shaft of a screw press,

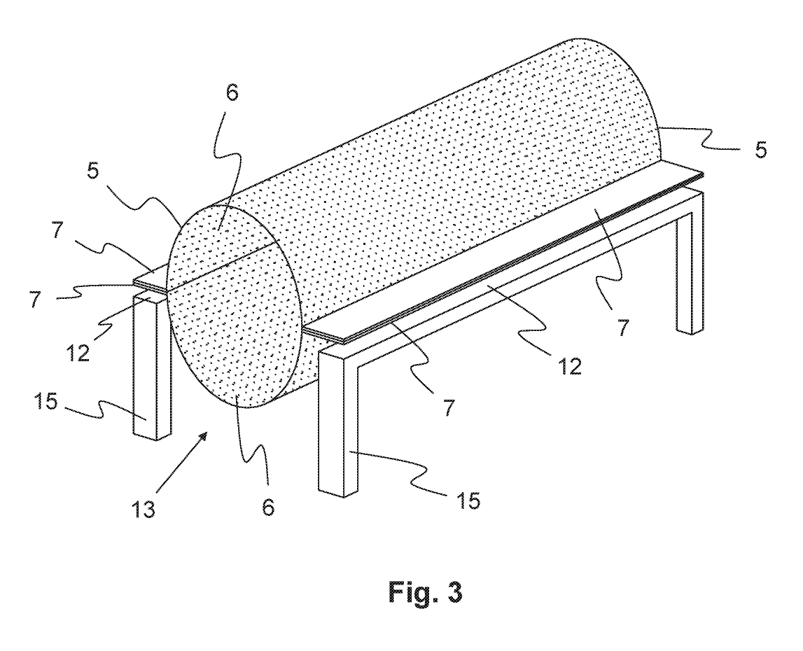

FIG. 3 the screen basket of a screw press above two holding units,

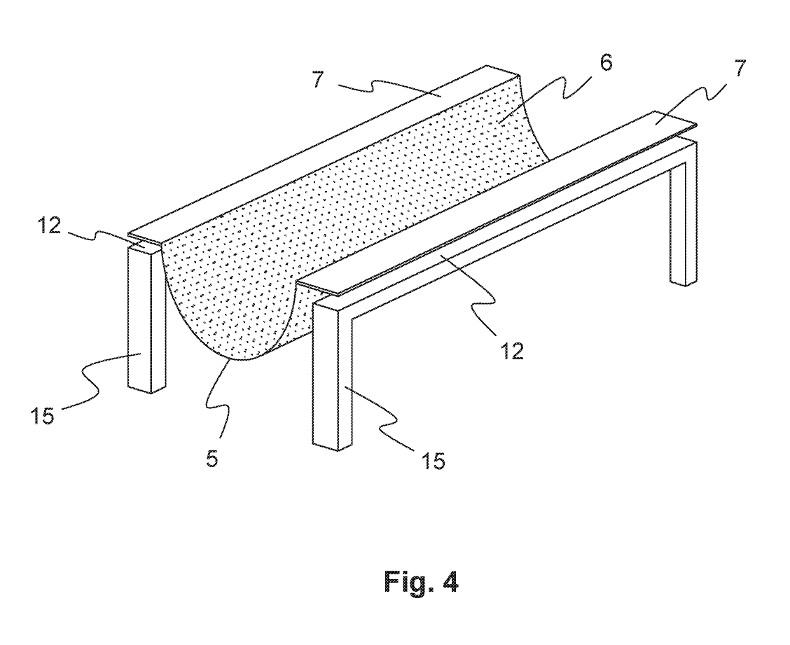

FIG. 4 the lower screen element of the screen basket shown in FIG. 3 after the removal of the upper screen basket,

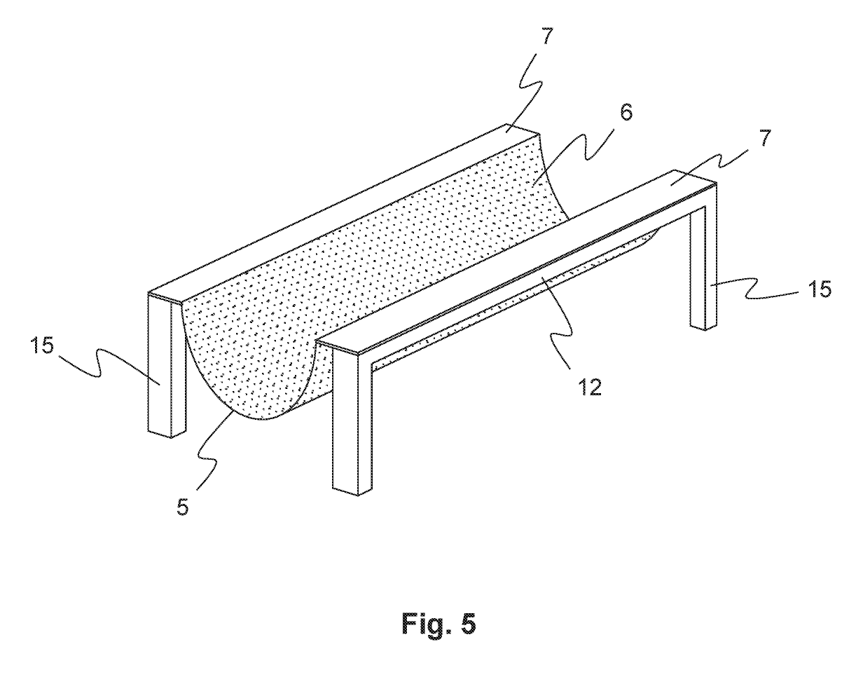

FIG. 5 the screen element shown in FIG. 4 after being lowered onto the holding units and

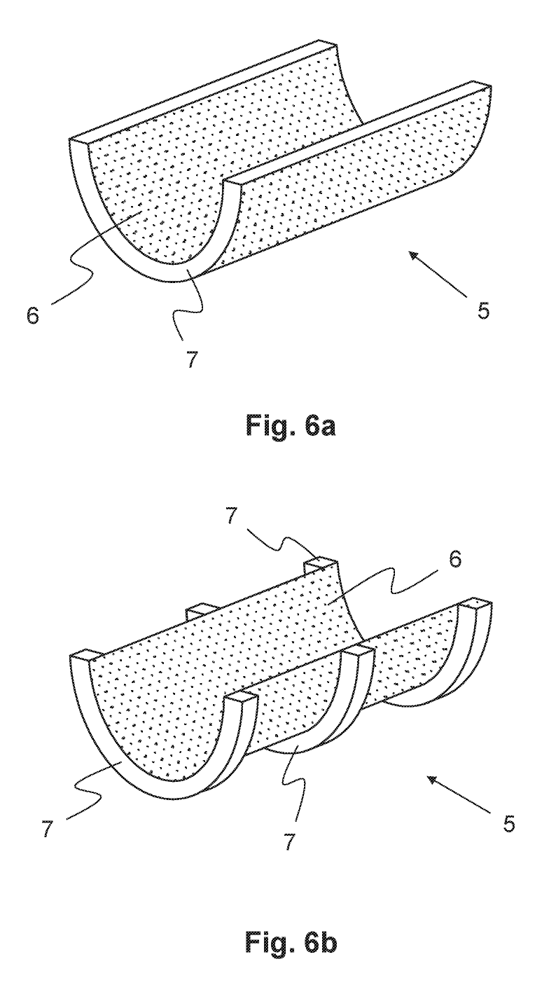

FIGS. 6a and 6b two differently formed screen elements.

FIG. 1 shows the essential elements of a screw press 1 for dewatering sludge.

In principle, the screw press 1, which is supported by means of a corresponding support structure 7 (which, in addition to the standing legs shown, may also include various longitudinal and/or transverse beams or other frame elements), also has an inlet opening 2 for the sludge 11 to be dewatered (which may be connected, for example, to a sludge feed line 18, through which the sludge is fed).

Subsequent to the inlet opening 2, a pressing assembly extends; this comprises a worm shaft 4 that is displaceable into a rotational movement by a drive 17 (the axis of rotation is provided with the reference sign 14), which in turn preferably features an axle 19 with one or more worm spirals 3 arranged thereabove and is surrounded by a multiple number of screen elements 5, whereas the screen elements 5 together form a preferably cylindrical screen jacket 13. Of course, the screen jacket 13 may also feature conical sections, such that the cylindrical shape serves only as an example.

As can be seen in this connection from the variants of a screen element 5 shown in FIGS. 6a and 6b, regardless of its precise design, which can deviate from the variants show, this comprises a support structure 7 along with a screen surface 6 turned towards the worm shaft 4 in the installed state. Thereby, the support structure 7 may be formed, for example, by a plate featuring numerous perforations, which at the same time features the inwardly directed screen surface 6 (see FIG. 6a). Likewise, the screen surface 6 may be formed by a two-dimensional structure that features additional reinforcements or struts, which in this case form the support structure 7 (see FIG. 6b).

Through the changing, preferably decreasing, slope of the worm spiral 3 and/or its possibly changing, preferably increasing outer diameter in the direction of a discharge opening 10, the sludge is ultimately pressed together and from the inside against the screen surfaces 6 of the screen elements 5, by which it arrives at the outlet of liquid 9 through the openings (holes or slots) of the screen surfaces 6. For the support the pressing process, the dewatering device preferably has a counter-surface, for example, in the form of the pressure cone 20 that is shown. Thereby, the pressure cone 20 is located in the top end area of the worm shaft 4 and, with a corresponding outer wall, forms a ring-shaped gap that can be passed by the dewatered sludge 11. Through the adjustment of the pressure cone 20 in the axial direction of the worm shaft 4, the specified gap ultimately may be changed, and thus the counter-pressure may be adjusted during the pressing process (for this purpose, for example, one or more (for example, pneumatically operated) adjusting elements are available).

Finally, the liquid 9 is collected by one or more filtrate tanks 16 arranged below the worm shaft 4 and is guided in the direction of an outlet opening 8. There, it can be removed, for example, with the assistance of a hose assembly (not shown) or can be collected with the assistance of a collecting device.

In turn, the sludge (which is not shown for the sake of clarity, but is located between the worm shaft 4 and the screen surface 6) reaches the specified discharge opening 10 after passing through the pressing assembly. Finally, the sludge components retained by the screen surface 6 may be collected in the form of the dewatered sludge 11 and, where needed, fed to a further process.

In order to ensure that the sludge is reliably transported from the worm shaft 4 to the area of the discharge opening 10 and is thereby dewatered, it is advantageous to provide the worm spiral 3 with a scraper profile 21 in its outer area adjacent to the screen surface 6. FIG. 2 shows a cut-out of a correspondingly equipped worm shaft 4. Since, as a rule, the scraper profile 21 rests against the stationary screen surface 6, friction-induced wear occurs, such that the scraper profile 21 must be replaced at certain time intervals.

In this connection, it is known either to completely remove the worm shaft 4 or, on the other hand, to remove the screen elements 5 from the screw press 1, in order to free the worm shaft 4. In both cases, there is a need for additional space, in order to be able to put down the worm shaft 4 or the screen elements 5 next to the screw press 1.

In order to counteract this disadvantage, in accordance with the invention, it is now proposed that the screw press 1 itself has one or more holding units 12, with the assistance of which one or more screen elements 5 or at least their support structure(s) 7 (see FIGS. 6a and 6b) can be fixed in a maintenance position.

The fundamental idea of the invention is explained below with reference to the example of FIGS. 3 to 5.

In principle, the screw press 1 in accordance with the invention comprises a multiple number of screen elements 5, which together form a screen jacket 13, which surrounds the worm shaft 4, at least in sections. In the example of FIG. 3, the screen jacket 13 comprises two similar screen elements 5, which, with the assistance of means (such as screws) that are not shown, are held in a position in which they together form the screen jacket 13. The screen elements 5 can be connected to each other and/or can be detachably fastened to holding sections (not shown) of a base carrier 15 of the screw press 1. At this point, it should be pointed out that FIGS. 3 to 5 show the screen elements 5 along with a base carrier 15 of the screw press 1 exclusively and in a highly schematized manner. Of course, the screw press 1 also comprises additional elements (see FIG. 1), but such elements are not shown for reasons of clarity.

In any event, the invention now provides one or more holding units 12, which are, for example, part of the base carrier 15 of the screw press 1 or are fastened to the screw press 1 (the base carrier 15 includes, in particular, transverse and/or longitudinal struts, which form a certain frame structure). If the worm shaft 4 is now to be serviced (in particular, if its scraper profile 21 is to be replaced), the screen elements 5 must be removed spatially from the worm shaft 4. While the screen element 5 lying above in FIG. 3, or at least its support structure 7, can be easily removed (compare FIGS. 3 and 4), the removal of the screen element 5 lying below or the support structure 7 thereof is generally problematic, since, due to the worm shaft 3 present in the screw press 1, lifting is ruled out, and a downward removal generally entails the removal of the filtrate tank 16.

By contrast, by means of the holding unit(s) 12, it is now possible to lower the lower screen element 5 or at least its support structure 7 within the screw press 1 and without the removal of the worm shaft 4 or the filtrate tank 16, and to fix it in a position above the filtrate tank 16. The corresponding downwardly lowered screen element 5 is shown in FIG. 5, in which the laterally outwardly protruding sections of the support structure 7 are put down on the holding units 12 lying underneath, and are thus spatially fixed. After the maintenance work has been completed, the previously lowered screen element 5 or its support structure 7 can finally be raised again and fixed in its operating position, followed by the corresponding mounting of the upper screen element 5 or its support structure 7.

It would also be conceivable, alternatively or additionally, to fix the upper screen element 5 or its support structure 7 in a maintenance position with the assistance of or more holding units 12, whereas, in this case, the corresponding holding units 12 are to be arranged above the worm shaft 4.

This invention is not limited to the illustrated and described embodiments. Variations within the framework of the claims, such as any combination of the described characteristics, are also possible, even if they are presented and described in different parts of the description and/or the claims, or in different embodiments.

In particular, it is advantageous if the screw press comprises a cleaning device for cleaning the screen surfaces. This may comprise, for example, a tube and/or frame structure and one or more spray nozzles, which are directed from the outside against the screen elements, in order to be able to clean the screen surfaces in the counter-flow. The pipe and/or frame structure, through which a cleaning liquid (such as water) can be supplied to the spray nozzles, preferably extends around the screen jacket comprising the screen elements. For example, it would be conceivable for the cleaning device to feature two ring structures that run parallel and are spaced apart from each other in the axial direction of the worm shaft, which are connected, in a manner surrounding the screen jacket, in the axial direction by a multiple number of longitudinal struts, whereas the spray nozzles are parts of the longitudinal struts or are connected to them.

In any event, it is advantageous if the cleaning device surrounds the screen jacket in a cage-like manner and/or can be displaced in a rotational movement around the axis of rotation of the worm shaft, in order to be able to clean the entire screen surface in the counter-flow.

Furthermore, it is advantageous if the cleaning device can be disassembled into a multiple number of individual sections, such that the cleaning device can be disassembled prior to the removal in accordance with the invention of individual screen elements or their support structures, and can also be removed from their operating position (this facilitates the subsequent movement of the screen elements or their support structures in the manner described above). Preferably, the cleaning device can be disassembled into two or more similar sections, whereas the separation of the sections is preferably possible along one or more planes, which extend parallel to the axis of rotation of the worm shaft.

### LIST OF REFERENCE SIGNS

1 Screw press
2 Inlet opening
3 Worm spiral
4 Worm shaft
5 Screen element
6 Screen surface
7 Support structure
8 Outlet opening
9 Liquid
10 Discharge opening
11 Dewatered sludge
12 Holding unit
13 Screen jacket
14 Axis of rotation of the worm shaft
15 Base carrier
16 Filtrate tank
17 Drive
18 Sludge feed line
19 Axis of the worm shaft
20 Pressure cone
21 Scraper profile

1. Screw press (1) for dewatering sludge,
whereas the screw press (1) features at least one inlet opening (2) for the sludge to be dewatered,
whereas the screw press (1) features a pressing assembly, with the assistance of which the sludge is able to undergo a pressing process after passing the inlet opening (2), with which the liquid (9) present in the sludge is least partially driven out of the sludge,
whereas a pressing assembly comprises a worm shaft (4) that is movable in a rotational movement with the assistance of a drive (17) and several screen elements (5) surrounding the worm shaft (4), at least in sections, during the operation of the screw press (1), whereas the screen elements (5) feature a screen surface (6) turned towards the worm shaft (4) and a support structure (7) securing the stability of the screen elements (5),
whereas the pressing assembly features at least one outlet opening (8) for the liquid (9) driven out of the sludge with the assistance of the worm shaft (4), and
whereas the screw press (1) features at least one discharge opening (10) for the sludge (11) that is at least partially dewatered with the assistance of the pressing assembly,
characterized in that the screw press (1) features at least one holding unit (12), with the assistance of which at least the support structure (7) of at least one screen element (5) can be fixed in a maintenance position, in which the screen surface (6) of the corresponding screen element (5) is spaced apart from the worm shaft (4).

2-14. (canceled)
